(19) United States
(12) Patent Application Publication
(10) Pub. No.: US 2012/0152052 A1
(43) Pub. Date: Jun. 21, 2012

(54) MANIPULATION DEVICE

(76) Inventor: Katsutoshi SUZUKI, Miyagi-ken (JP)

(21) Appl. No.: 13/292,494

(22) Filed: Nov. 9, 2011

(30) Foreign Application Priority Data
Dec. 17, 2010 (JP) 2010-256804

(51) Int. Cl. G05G 1/10

(52) U.S. Cl. 74/504

(57) ABSTRACT

A spherical surface is provided in an operation body rotated by a manipulation body, and a detection portion is provided so as to detect a rotation of the operation body. The spherical surface is provided with a radial concave portion of a first set and concentric concave portions of a second set, a protrusion is provided so as to be fitted to the concave portions of the first set, and a protrusion is provided so as to be fitted to the concave portions of the second set. When the manipulation body is manipulated so as to push down or rotate the operation body, a sense of resistance is given to a hand from the concave portions of the first set and the second set.

### CLAIM OF PRIORITY

This application claims benefit of Japanese Patent Application No. 2010-256804 filed on Nov. 17, 2010, which is hereby incorporated by reference in its entirety.

### BACKGROUND

1. Field of the Disclosure

The present disclosure relates to a manipulation device of which a manipulation body is able to be pushed down in multiple directions or is rotatable while being pushed down, and particularly, a manipulation device which is able to give a sense of manipulation to a person manipulating a manipulation body.

2. Description of the Related Art

A manipulation device capable of obtaining a detection output when pushing a manipulation body down in multiple directions has been used in various electronic apparatuses such as a game device or a car navigation device.

The manipulation device includes an operation body and a stick-like manipulation body extending from the operation body. The operation body is supported so as to be rotatable about two axes, and a detection portion is provided so as to detect a rotation of the operation body about each axis through a change in resistance value.

A manipulation device disclosed in Japanese Unexamined Patent Application Publication No. 2005-209442 includes an elastic member that returns an operation body and a manipulation body to a neutral position. When the manipulation body is largely pushed down, an edge of a sliding member provided at the lower portion of the operation body ascends a housing, so that the sense of resistance given to a hand manipulating the manipulation body increases.

A manipulation device disclosed in Japanese Unexamined Patent Application Publication No. 2002-108557 includes an operation body of which a surface is a spherical surface. A step is formed in the spherical surface of the operation body, and a support portion is elastically pressed against the step by a spring. Even in the manipulation device, when the manipulation body is largely pushed down, the support portion ascends the step, so that the sense of resistance given to a hand manipulating the manipulation body increases.

In the disclosure described in Japanese Unexamined Patent Application Publication Nos. 2005-209442 and 2002-108557, when the angle of pushing the manipulation body down is large, the load acting on the manipulating hand increases, but various changes in the sense of manipulation corresponding to the manipulation of the manipulation body in all of the directions may not be given to the hand.

For example, a change in the sense of manipulation may not be intermittently generated in accordance with a rotary angle when pushing down and rotating the manipulation body or a change in the sense of manipulation may not be generated in accordance with the degree of the angle of pushing the manipulation body down. Furthermore, the manipulation body may not be temporarily stopped in a neutral posture or a predetermined manipulation posture or the manipulation body may not be first guided by a predetermined manipulation method.

### SUMMARY

The present invention provides a manipulation body which gives various changes in sense of manipulation to a hand in accordance with a manipulation direction or a manipulation procedure when manipulating a manipulation body so as to rotate an operation body.

According to a first aspect of the invention, there is provided a manipulation device including: an operation body of which at least a part of the surface is provided with a spherical surface and which is rotatably supported by a support base; a manipulation body which rotates the operation body; and a detection portion which detects a rotation of the operation body, wherein the spherical surface is provided with a concave portion, the support base is provided with a protrusion elastically pressed against the operation body and sliding on the spherical surface and the concave portion, and a plurality of the concave portions is provided in a radial shape about an intersection point between the spherical surface and a normal line thereof.

According to a second aspect of the invention, there is provided a manipulation device including: an operation body of which at least a part of the surface is provided with a spherical surface and which is rotatably supported by a support base; a manipulation body which rotates the operation body; and a detection portion which detects a rotation of the operation body, wherein the spherical surface is provided with a concave portion, the support base is provided with a protrusion elastically pressed against the operation body and sliding on the spherical surface and the concave portion, and a plurality of the concave portions is provided in a concentric shape about an intersection point between the spherical surface and a normal line thereof.

According to a third aspect of the invention, there is provided a manipulation device including: an operation body of which at least a part of the surface is provided with a spherical surface and which is rotatably supported by a support base; a manipulation body which rotates the operation body; and a detection portion which detects a rotation of the operation body, wherein the spherical surface is provided with at least concave portions of first and second sets, the support base is provided with a protrusion elastically pressed by the operation body and individually sliding on the concave portion of each set and the spherical surface, a plurality of the concave portions of the first set is provided in a radial shape about an intersection point between the spherical surface and a first normal line thereof, and a plurality of the concave portions of the second set is provided in a concentric shape about an intersection point between the spherical surface and a second normal line thereof.

According to a fourth aspect of the invention, there is provided a manipulation device including: an operation body of which at least a part of the surface is provided with a spherical surface and which is rotatably supported by a support base; a manipulation body which rotates the operation body; and a detection portion which detects a rotation of the operation body, wherein the spherical surface is provided with a concave portion, the support base is provided with a protrusion elastically pressed against the operation body and sliding on the spherical surface and the concave portion, and when the concave portion is fitted to the protrusion, the operation body is temporarily stopped.

According to a fifth aspect of the invention, there is provided a manipulation device including: an operation body of which at least a part of the surface is provided with a spherical surface and which is rotatably supported by a support base; a manipulation body which rotates the operation body; and a detection portion which detects a rotation of the operation body, wherein the spherical surface is provided with a concave portion, the support base is provided with a protrusion elastically pressed against the operation body and sliding on the spherical surface and the concave portion, the concave portion extends in one rotation direction, and when the protrusion is fitted to the concave portion, the operation body is first guided in the direction along the concave portion.

### BRIEF DESCRIPTION OF THE DRAWINGS

FIG. 1 is a perspective view illustrating an overall structure of a manipulation device of a first embodiment of the invention;

FIG. 2 is an exploded perspective view illustrating a main part of the manipulation device of the first embodiment;

FIG. 3 is a bottom view illustrating an operation body provided in the manipulation device of the first embodiment;

FIG. 4 is a bottom view illustrating an operation body of a manipulation device of a second embodiment of the invention;

FIG. 5 is a bottom view illustrating a main part of a manipulation device of a third embodiment of the invention;

FIG. 6 is a bottom view illustrating the operation body provided in the manipulation device of the third embodiment;

FIG. 7 is a bottom view illustrating an operation body provided in a manipulation device according to another embodiment of the invention;

FIG. 8 is a bottom view illustrating an operation body provided in a manipulation device according to another embodiment of the invention;

FIG. 9 is a bottom view illustrating an operation body provided in a manipulation device according to another embodiment of the invention;

FIG. 10 is a bottom view illustrating an operation body provided in a manipulation device according to another embodiment of the invention;

FIG. 11 is a bottom view illustrating an operation body provided in a manipulation device according to another embodiment of the invention;

FIG. 12 is a bottom view illustrating an operation body provided in a manipulation device according to another embodiment of the invention;

FIG. 13 is a bottom view illustrating an operation body of an embodiment in which three or more sets of concave portions are provided; and

FIG. 14 is a bottom view illustrating an operation body of an embodiment in which three or more sets of concave portions are provided.

### DESCRIPTION OF THE EXEMPLARY EMBODIMENTS

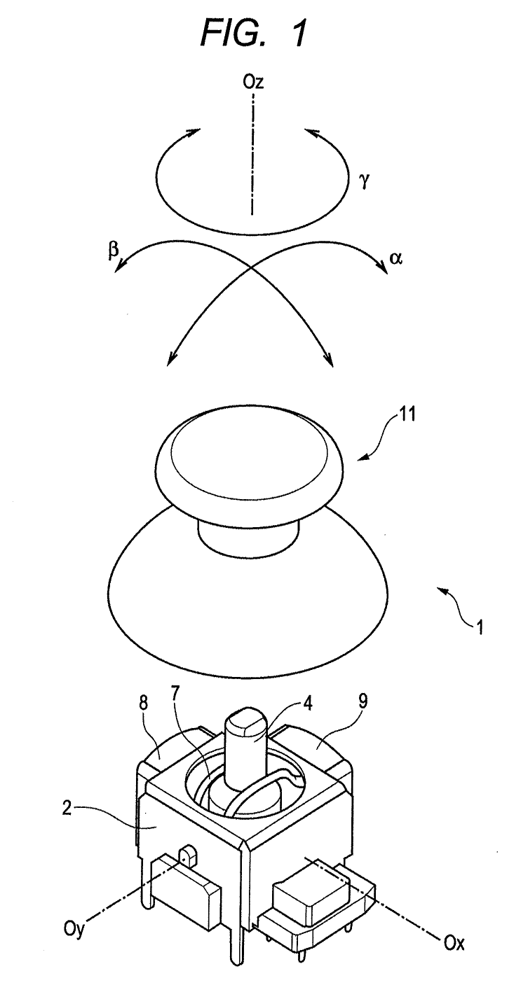

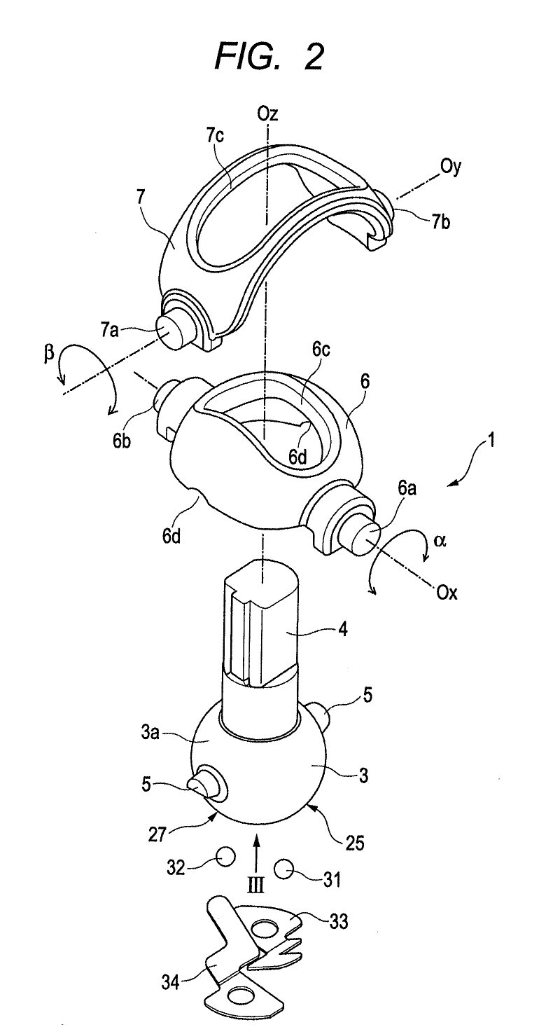

A manipulation device 1 of a first embodiment shown in FIGS. 1 and 2 includes a support base 2, an operation body 3 that is rotatably supported inside the support base 2, and a shaft-like manipulation body 4 that integrally extends from the operation body 3.

As shown in FIG. 2, a part of the surface of the operation body 3 is formed as a spherical surface 3a. A support portion with a concave spherical surface shape is provided inside the support base 2. The spherical surface 3a is slidably supported by the support portion, so that the operation body 3 is rotatable in the respective directions about the curvature center of the spherical surface 3a serving as the support point.

A first rotary member 6 and a second rotary member 7 shown in FIG. 2 are provided inside the support base 2.

Shafts 6a and 6b are integrally formed with the first rotary member 6 so as to extend from both ends thereof in the Ox direction. The shafts 6a and 6b are supported inside the support base 2 so as to be rotatable in the α direction about the Ox axis serving as the center. The Ox axis is an imaginary line passing through the curvature center of the spherical surface 3a of the operation body 3. A sliding elongated hole 6c is formed in the first rotary member 6 so as to extend in the Ox direction. The manipulation body 4 is inserted into the sliding elongated hole 6c so as to be directed upward. Support concave portions 6d and 6d are formed in the lower edge of the first rotary member 6. Small protrusions 5 and 5 are integrally formed with the operation body 3 so as to protrude toward both sides of the Oy direction. The small protrusions 5 and 5 inside the support base 2 are respectively fitted to the support concave portions 6d and 6d, so that the operation body 3 and the first rotary member 6 are rotatable in the α direction about the Ox axis serving as the center while being combined with each other.

Shafts 7a and 7b are integrally formed with the second rotary member 7 so as to extend from both ends thereof in the Oy direction, and the shafts 7a and 7b are supported inside the support base 2 so as to be rotatable in β direction about the Oy axis serving as the center. The Oy axis is an imaginary line passing through the curvature center of the spherical surface 3a of the operation body 3. A sliding elongated hole 7c is formed in the second rotary member 7 so as to extend in the Oy direction, and the manipulation body 4 is inserted into the sliding elongated hole 6c of the first rotary member 6 from the downside thereof and is further inserted into the sliding elongated hole 7c upward from the downside thereof.

A neutral spring is provided inside the support base 2, and may stabilize the operation body 3 in a neutral posture in which the axis center of the manipulation body 4 extends in the Oz direction.

As shown in FIG. 1, two detection portions 8 and 9 are provided in the support base 2. Each of the detection portions 8 and 9 has a configuration in which an arc-shaped resistor is provided on a substrate provided inside the detection portion and a rotor is provided so as to rotate about the arc center of the resistor serving as the axis, and a conductive slider is provided in the rotor so as to slide on the resistor.

When the rotor is rotated by the shaft 6b of the first rotary member 6, one detection portion 8 may obtain a change in resistance value proportional to the degree of the rotary angle of the first rotary member 6 in the α direction in the form of a detection output. When the rotor is rotated by the shaft 7b of the second rotary member 7, the other detection portion 9 may obtain a change in resistance value proportional to the degree of the rotary angle of the second rotary member 7 in the β direction in the form of a detection output.

As shown in FIG. 1, the manipulation body 4 protrudes upward along the Oz axis from the support base 2. A manipulation button 11 is attached to the manipulation body 4 while the manipulation device 1 is mounted on each of manipulation units of various electronic apparatuses. The manipulation button 11 is formed of a material such as synthetic rubber which gives a satisfactory sensation to an operator's hand.

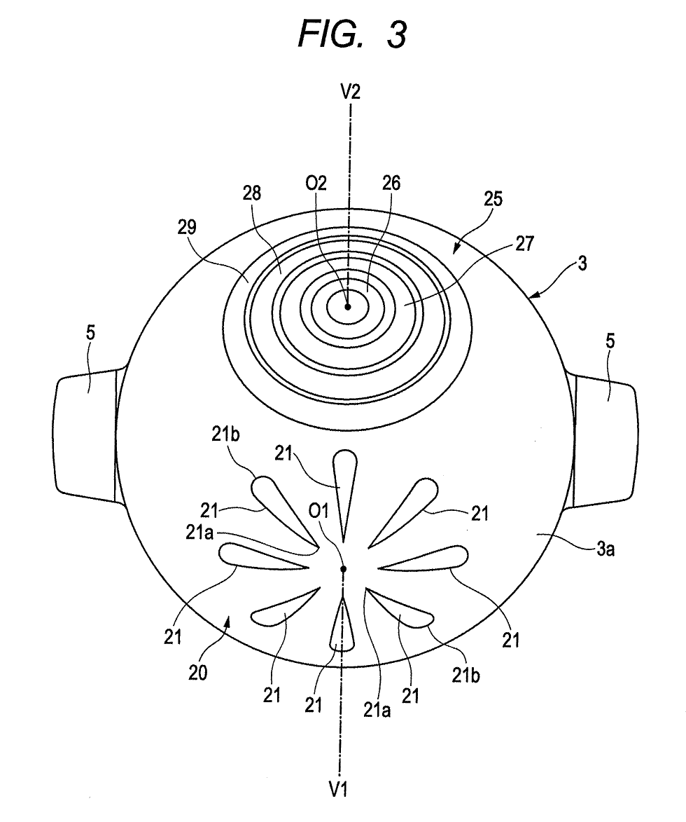

FIG. 3 is a bottom view when the operation body 3 is seen from the bottom, that is, in the direction indicated by III shown in FIG. 2. As shown in FIG. 3, the spherical surface 3a of the operation body 3 is provided with a plurality of concave portions constituting two sets.

A first set 20 includes a plurality of concave portions 21 extending in a linear shape. FIG. 3 shows a first normal line V1 with respect to the spherical surface 3a and a first center O1 corresponding to an intersection point between the first normal line V1 and the spherical surface 3a. The respective concave portions 21 extend in a radial shape from the first center O1. The concave portions 21 are formed so as to have the same angle in the rotation direction about the first center O1. The embodiment of FIG. 3 includes eight concave portions 21, and the arrangement angular pitch between the concave portions 21 in the rotation direction is 45°.

In the first set 20, an inner peripheral end 21a of the concave portion 21 is slightly separated from the first center O1. An inner peripheral end 21a of each concave portion 21 is separated from the first center O1 by the same distance, and the outer peripheral end 21b of each concave portion 21 is separated from the first center O1 by the same distance. The depth of each concave portion 21 from the spherical surface 3a gradually increases as it moves from the inner peripheral end 21a toward the outer peripheral end 21b.

As shown in FIG. 3, the second set 25 is provided with a plurality of annular concave portions 26, 27, 28, and 29. FIG. 3 shows a second normal line V2 of the spherical surface 3a and a second center O2 corresponding to an intersection point between the second normal line V2 and the spherical surface 3a. The plurality of annular concave portions 26, 27, 28, and 29 is formed in a concentric shape with respect to the second center O2. Further, the depth from the spherical surface 3a gradually increases in an order of the concave portion 26, the concave portion 27, the concave portion 28, and the concave portion 29.

As shown in FIG. 2, a first protrusion 31 and a second protrusion 32 are provided inside the support base 2. Both protrusions 31 and 32 are spherical bodies, where the first protrusion 31 is formed with a diameter dimension in which the protrusion may be fitted to each concave portion 21 of the first set 20, and the second protrusion 32 is formed with a diameter dimension in which the protrusion may be fitted to each of the concave portions 26, 27, 28, and 29 of the second set 25. Further, the support base 2 has therein a first elastic member 33 which elastically presses the first protrusion 31 against the concave portion 21 of the first set and the spherical surface 3a and a second elastic member 34 which elastically presses the second protrusion 32 against the concave portions 26, 27, 28, and 29 of the second set 25 and the spherical surface 3a. The first elastic member 33 and the second elastic member 34 are both plate springs.

Next, an operation of the manipulation device 1 of the first embodiment will be described.

When an external force is not exerted on the manipulation button 11, the operation body 3 is stabilized by the neutral spring in the neutral posture in which the axial direction of the manipulation body 4 is directed to the Oz direction.

When the manipulation button 11 is manipulated so as to push the manipulation body 4 down in the α direction, the first rotary member 6 rotates about the Ox axis serving as the center in accordance with the rotation of the operation body 3, and a detection output based on a change in resistance proportional to the rotary angle may be obtained from the detection portion 8. When the manipulation button 11 is manipulated so as to push the manipulation body 4 down in the β direction, the second rotary member 7 rotates about the Oy axis serving as the center in accordance with the rotation of the operation body 3, and a detection output based on a change in resistance proportional to the rotary angle may be obtained from the detection portion 9. Further, the manipulation body 4 may be pushed down in multiple directions obtained by the combination of the α and β directions, and at this time, a detection output based on a change in resistance may be obtained from both the detection portion 8 and the detection portion 9.

Further, the manipulation body 4 may be rotated about the γ direction shown in FIG. 1 using the Oz axis as the center while being pushed down from the neutral posture. Even at this time, the rotation component of the first rotary member 6 in the α direction is detected by the detection portion 8, and the rotation component of the second rotary member 7 in the β direction is detected by the detection portion 9.

When the manipulation body 4 is in the neutral posture directed toward the Oz axis, the first protrusion 31 shown in FIG. 2 comes into press-contact with the first center O1 of the spherical surface 3a shown in FIG. 3, and the second protrusion 32 comes into press-contact with the second center O2.

When the manipulation button 11 and the manipulation body 4 are manipulated to be pushed down in the α or β direction or in the direction other than the α and β directions from the neutral posture, the second protrusion 32 in the second set 25 shown in FIG. 3 slides in the radial direction about the second center O2 serving as the base point. At this time, the second protrusion 32 alternately slides on the spherical surface 3a and the annular concave portions 26, 27, 28, and 29, and a change in resistance acts on a hand pushing the manipulation button 11 down whenever the second protrusion 32 falls into the concave portions 26, 27, 28, and 29 and ascends the spherical surface 3a from the concave portions 26, 27, 28, and 29, thereby giving a sense of stepwise manipulation to the hand.

As it moves away from the center O2 in an order from the concave portion 26 near the second center O2 to the concave portions 27, 28, and 29, the depth of the concave portion from the spherical surface 3a increases in a stepwise manner. For this reason, the resistance given to the hand becomes larger in a stepwise manner as the angle of pushing the manipulation button 11 and the manipulation body 4 down from the neutral posture becomes larger. Accordingly, a manipulator may easily understand the degree of the angle of pushing the manipulation button 11 and the manipulation body 4 down through the sensation in the hand.

Furthermore, when the pitches from the second center O2 to the centers of the concave portions 26, 27, 28, and 29 in the radial direction are set to be the same, the manipulator senses sliding resistance at each push-down angle when pushing the manipulation button 11 and the manipulation body 4 down. Alternatively, the pitches from the centers of the concave portions 26, 27, 28, and 29 may be set to become larger further away from the second center O2. Accordingly, the pitch sensing resistance when largely pushing the manipulation button 11 and the manipulation body 4 down is widened, so that the manipulator may easily understand a large push-down angle through the sensation in the hand.

When the manipulation button 11 and the manipulation body 4 are rotated in the γ direction about the Oz axis while being pushed down from the neutral posture, the first protrusion 31 alternately slides on the spherical surface 3a and the concave portion 21 of the first set 20, and whenever the protrusion falls into the concave portion 21 and ascends the spherical surface 3a from the concave portion 21, a sense of resistance is given to the hand manipulating the manipulation button 11. Accordingly, it is easy to understand how much and fast the manipulation button 11 is rotated at the time of rotating the manipulation button 11 through the sensation in the hand.

As shown in FIG. 3, since the inner peripheral end 21a of the concave portion 21 of the first set 20 is separated from the first center O1, the first protrusion 31 does not fall into the concave portion 21 at the time of pushing the manipulation button 11 and the manipulation body 4 down by a small angle from the neutral posture so as to rotate in the γ direction, so that the sense of resistance is not given to the hand. Therefore, it is possible to smoothly perform a rotation operation when gradually pushing the manipulation body 4 down so as to rotate about the Oz axis, and to control a minute input operation.

Further, the depth of the concave portion 21 from the spherical surface 3a becomes larger as it moves from the inner peripheral end 21a toward the outer peripheral end 21b. Therefore, the sense of resistance given from the concave portion 21 to the hand is small when the manipulation button 11 and the manipulation body 4 are slightly pushed down from the neutral posture so as to rotate in γ direction, and the sense of resistance given to the hand is large when the manipulation button 11 and the manipulation body 4 are largely pushed down so as to rotate in the γ direction. Therefore, it is easy to understand how much the manipulation button 11 and the manipulation body 4 are rotated in the γ direction while being pushed down to a certain degree through the sensation in the hand.

As shown in FIG. 3, in the manipulation device 1, a plurality of concave portions of two sets 20 and 25 is formed in the spherical surface 3a of the operation body 3, where when the operation body 3 is in the neutral posture, the first protrusion 31 comes into contact with the center O1 of the concave portion of the first set 20, and the second protrusion 32 comes into contact with the center O2 of the concave portion of the second set 25. Therefore, it is possible to accurately distinguish different senses from the concave portion of the first set 20 and the concave portion of the second set 25 when the operation of pushing the manipulation body 4 down from the neutral posture and the operation of rotating the manipulation body are performed individually or together.

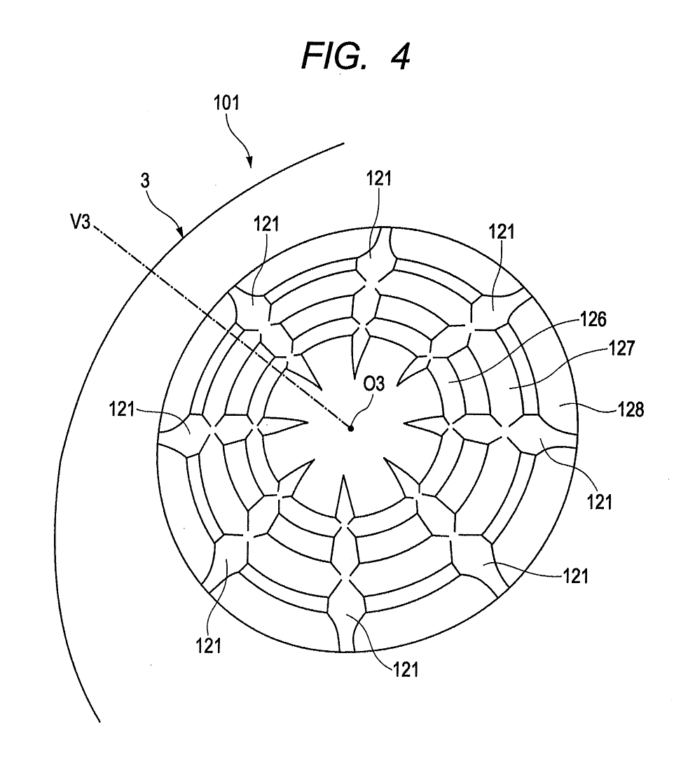

Next, in the operation body 3 used in a manipulation device 101 of the second embodiment shown in FIG. 4, a plurality of concave portions is formed in the spherical surface 3a.

In FIG. 4, a common center O3 is set at the intersection point between the normal line V3 of the spherical surface 3a and the spherical surface 3a. Then, a plurality of concave portions 121 extending in a radial shape from the common center O3 and a plurality of annular concave portions 126, 127, and 128 formed in a concentric shape with respect to the common center O3 are combined with each other.

In each of the plurality of concave portions 121 extending in a radial shape, the depth from the spherical surface 3a becomes larger further away from the common center O3, as in the concave portion 21 of the first set 20 shown in FIG. 3. Further, in the plurality of concave portions 126, 127, and 128, the depth of the concave portion closer to the common center O3 from the spherical surface 3a is small and the depth of the concave portion becomes larger further away from the common center O3, as in the concave portions 26, 27, 28, and 29 of the second set 25 shown in FIG. 3.

One spherical protrusion is provided in the support base 2, and the protrusion is pressed against the operation body 3 by the elastic member. When the operation body 3 is in the neutral posture, the protrusion comes into contact with the common center O3. When the manipulation body 4 is pushed down from the neutral posture, the sense of resistance is given to the manipulating hand in a stepwise manner by the concentric concave portions 126, 127, and 128. When the manipulation body 4 is rotated in a push-down posture, the sense of resistance is given to the manipulating hand from the radial concave portions 121 at the same angular pitch.

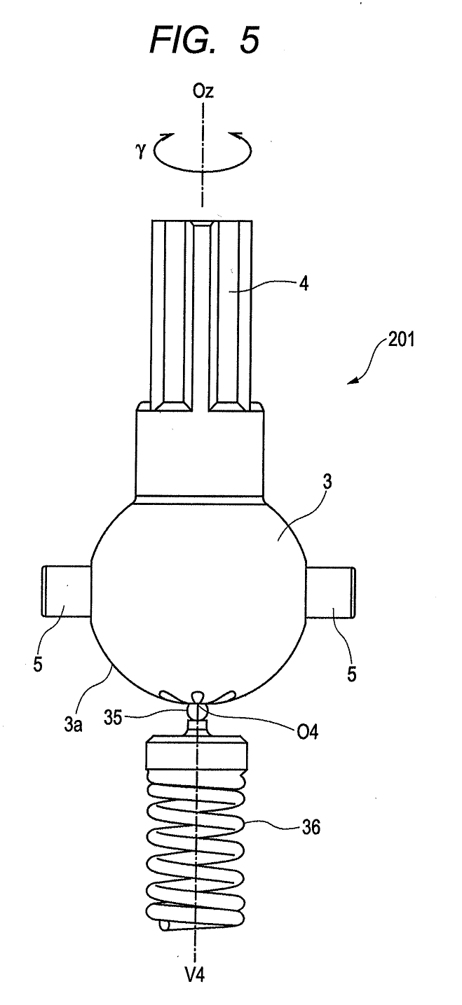

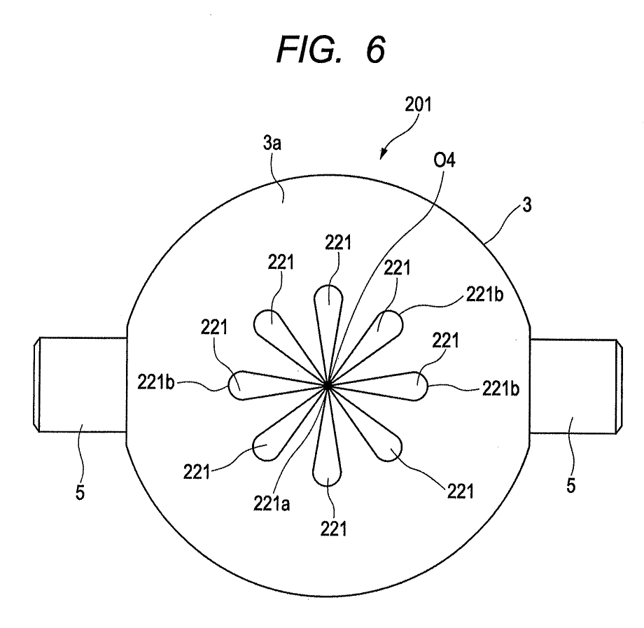

In a manipulation device 201 according to the third embodiment shown in FIGS. 5 and 6, one set of concave portions is formed in the bottom of the spherical surface 3a of the operation body 3. The plurality of concave portions 221 of the set extends in a radial shape with respect to the center O4 corresponding to the intersection point between the normal line V4 extending from the bottom of the spherical surface 3a in the Oz direction and the spherical surface 3a. An inner peripheral end 221a of each concave portion 221 extends up to the center O4. Further, the depth of each concave portion 221 from the spherical surface 3a gradually increases as it moves from the inner peripheral end 221a toward the outer peripheral end 221b.

The manipulation device 201 is provided with a spherical protrusion 35 which comes into contact with the center O4 when the operation body 3 is in the neutral posture and an elastic member 36 of a coil spring which elastically presses the protrusion 35 against the spherical surface 3a.

In the manipulation device 201, when the manipulation body 4 is rotated in the γ direction while being pushed down, the sense of resistance is given to the manipulating hand in accordance with the arrangement angular pitch of the concave portions 221. Further, since the depth of the concave portion 221 becomes larger as it moves toward the outer peripheral end 221b, the sense of resistance given to the hand becomes stronger as the push-down angle of the manipulation body 4 becomes larger.

As shown in FIG. 6, since the inner peripheral end 221a of each concave portion 221 extends up to the center O4, the sense of resistance may be obtained even when the manipulation body 4 is rotated while being slightly pushed down.

Furthermore, the operation body 3 may be provided with only the plurality of concave portions 26, 27, 28, and 29 of the second set 25 shown in FIG. 3.

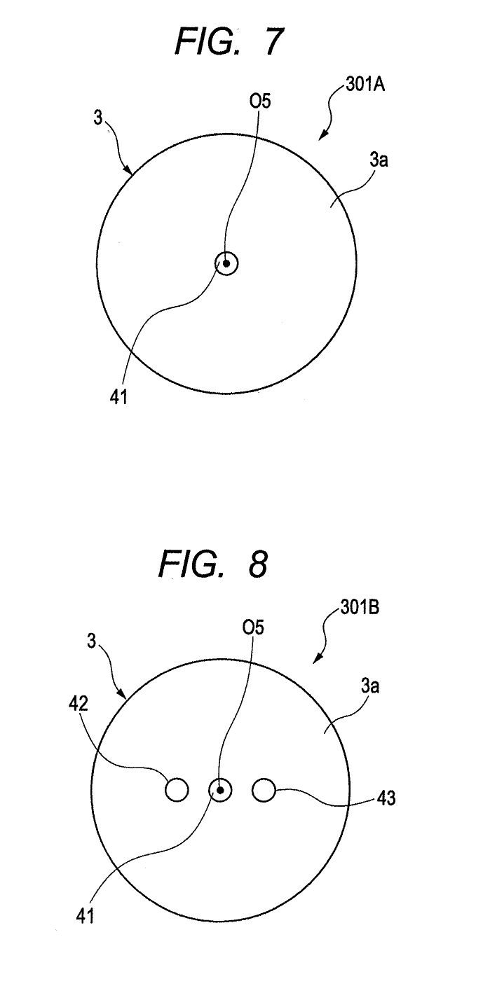

In a manipulation device 301A according to the fourth embodiment shown in FIG. 7, a concave portion 41 with a small concave spherical surface shape is formed at the center O5 corresponding to the intersection point between the normal line of the spherical surface 3a of the operation body 3 and the spherical surface 3a. A protrusion is provided so as to be fitted to the concave portion 41 when the operation body 3 is in the neutral posture, and the protrusion is elastically pressed against the operation body 3 by the elastic member.

The manipulation device 301A shown in FIG. 7 may rotate the operation body 3 in the respective directions by pushing the manipulation body 4 down or rotating the manipulation body while being pushed down. When the manipulation body 4 is in the neutral posture along the Oz axis, the protrusion is fitted to the concave portion 41, and the operation body 3 is temporarily stopped in the neutral posture. Accordingly, it is easy to understand whether the manipulation body 4 is returned to the neutral posture through the sensation in the hand.

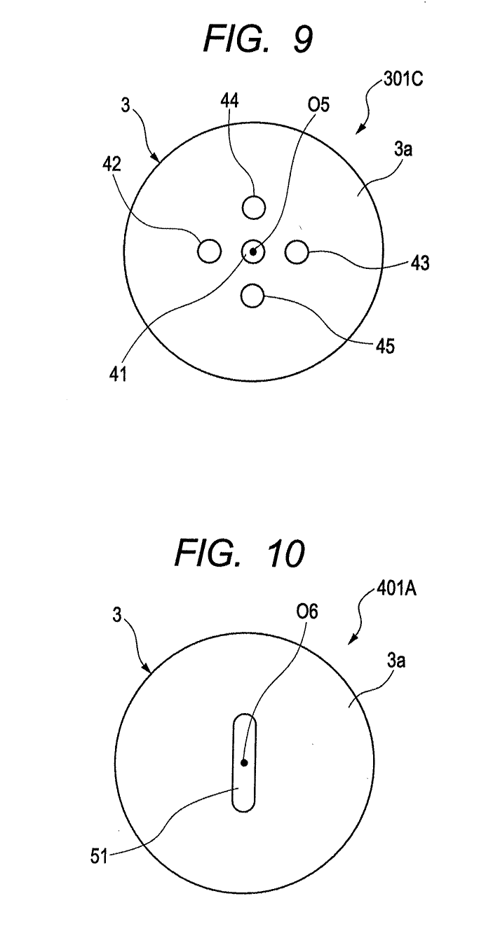

FIGS. 8 and 9 are modified examples of the fourth embodiment.

In a manipulation device 301B shown in FIG. 8, the spherical surface 3a of the operation body 3 is provided with a concave portion 41 which is positioned at the center O5 and has a concave spherical surface shape, and concave portions 42 and 43 with a concave spherical surface shape are provided at two positions distant therefrom in the lateral direction. Then, when the operation body 3 is in the neutral posture, the spherical protrusion is fitted to the central concave portion 41.

In the manipulation device 301B, when the manipulation body 4 is in the neutral posture, the operation body 3 is temporarily stopped. Then, even when the manipulation body 4 is pushed down leftward and rightward from the neutral posture by a predetermined angle, the protrusion is fitted to the concave portion 42 or the concave portion 43, so that the manipulation body 4 is temporarily stopped. Therefore, it is possible to understand whether the manipulation body 4 is in the neutral posture through the sense of resistance of the hand and understand whether the manipulation body 4 is rotated up to a predetermined manipulation position through the sense of resistance of the hand.

Further, as in the manipulation device 301C shown in FIG. 9, the spherical surface 3a may be provided with the concave portion 41 to which the protrusion is fitted in the neutral posture, and the concave portions 42, 43, 44, and 45 which are distant from each other in two directions perpendicular to each other of the concave portion 41.

In a manipulation device 401A according to the fifth embodiment shown in FIG. 10, the spherical surface 3a of the operation body 3 is provided with a concave portion 51 extending in a linear shape. When the center of the concave portion 51 is O6 and the operation body 3 is in the neutral posture, the spherical protrusion is fitted to the concave portion 51 at the center O6.

The manipulation device 401A may rotate the operation body 3 in all directions by manipulating the manipulation body 4. However, when the manipulation body 4 is pushed down in the direction in which the concave portion 51 extends while the protrusion is fitted to the concave portion 51, the sense of resistance of the hand is small. When the manipulation body 4 is pushed down in the other directions, the protrusion is deviated from the concave portion 51 so as to ascend the spherical surface 3a, so that the sense of resistance of the hand becomes larger. Therefore, the manipulation body may be first manipulated so as to be pushed down in the direction in which the concave portion 51 extends.

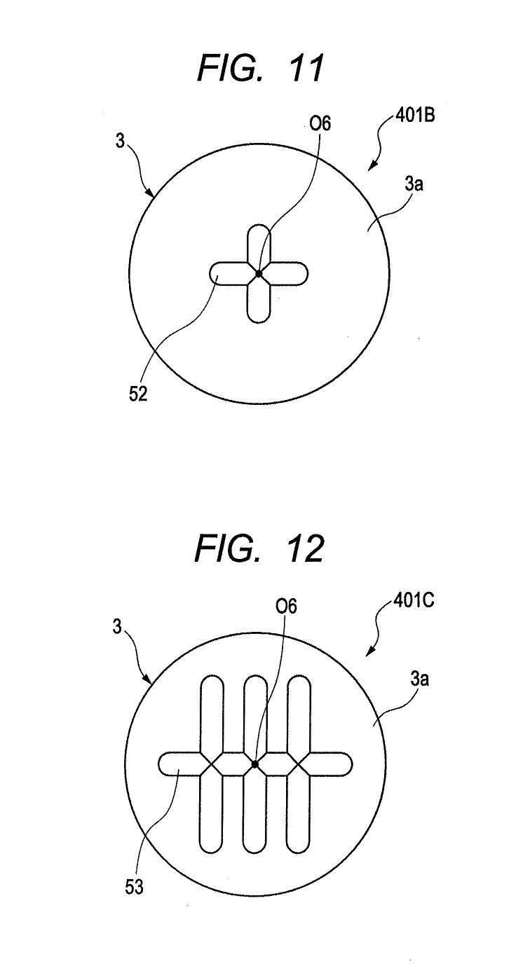

FIG. 11 shows a manipulation device 401B which is a modified example of the fifth embodiment. In the manipulation device 401B, when the operation body 3 is in the neutral posture, the protrusion is fitted to the concave portion 52 at the position of the center O6. When the manipulation body 4 is pushed down in two directions perpendicular to each other from the neutral posture, the sense of resistance of the hand is small. When the manipulation body is pushed down in the other directions, the resistance is large.

Further, as in a manipulation device 401C which is a modified example of the fifth embodiment shown in FIG. 12, the spherical surface 3a may be provided with a concave portion 53 extending in a plurality of rows.

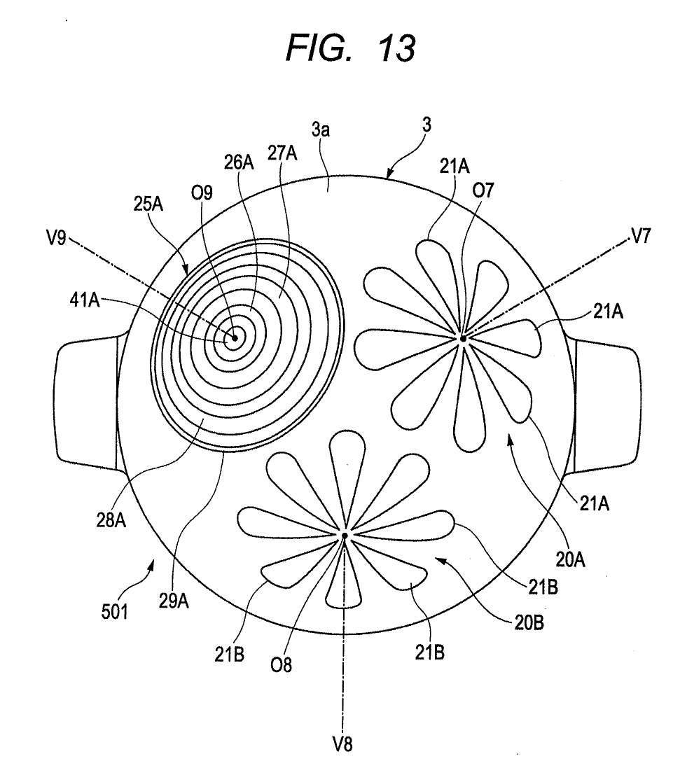

FIG. 13 is a bottom view illustrating the operation body 3 used in a manipulation device 501 according to a sixth embodiment of the invention. In the manipulation device 501, the spherical surface 3a is provided with four sets of concave portions.

One set 20A is formed based on the center O7 corresponding to the intersection point between the normal line V7 and the spherical surface 3a. A concave portion 21A of the set 20A is substantially the same as the plurality of concave portions 21 of the first set 20 shown in FIG. 3. A set 20B is formed based on the center O8 corresponding to the intersection point between the normal line V8 and the spherical surface 3a. A concave portion 21B of the set 20B is substantially the same as the concave portion 21 of the first set 20 shown in FIG. 3.

The set 20A includes eight concave portions 21A extending in a radial shape with respect to the center O7, and the set 20B includes eight concave portions 21B extending in a radial shape with respect to the center O8. However, the phase of the concave portion 21A in the set 20A in the rotation direction about the center O7 is deviated from the phase of the concave portion 21B in the set 20B in the rotation direction about the center O8 by 22.5°.

When the manipulation body 4 and the operation body 3 are in the neutral posture, the spherical protrusion individually comes into contact with the center O7 and the center O8 and is pressed by the elastic member. When the manipulation body 4 is pushed down from the neutral posture and is rotated, manipulation resistance is given to the manipulating hand whenever the concave portion 21A of the set 20A rotates by 45°. On the other hand, manipulation resistance is given to the manipulating hand between the adjacent concave portions 21A and 21A of the set 20A by the concave portion 21B of the set 20B.

For this reason, manipulation resistance is given whenever the manipulation body 4 and the operation body 3 are rotated by 22.5° due to eight concave portions 21A and 21B of two sets 20A and 20B, and manipulation resistance may be obtained sixteen times whenever the manipulation body 4 rotates once.

In the embodiment, even when the operation body 3 has a small diameter and the concave portions 21A and 21B of the sets 20A and 20B have minute dimensions, the sense of manipulation resistance may be obtained a plurality of times for one rotation. Furthermore, in the spherical surface 3a, only sets including the concave portions provided in a radial shape may be provided as three or more sets.

In a manipulation device 501 shown in FIG. 13, a plurality of concave portions is provided so as to constitute the set 25A about the center O9 corresponding to the intersection point between the normal line V9 and the spherical surface 3a. The set 25A is provided with concave portions 26A, 27A, 28A, and 29A which are disposed in a concentric shape. In the concave portions 26A, 27A, and 28A, the depths of the concave portions are set to be sequentially larger further from the center O9 as in the concave portions 26, 27, and 28 of the second set 25 shown in FIG. 3. However, the concave portion 29A positioned at the outermost periphery is shallower than the other concave portions 26A, 27A, and 28A.

Moreover, as a concave portion constituting another set, one concave portion 41A is formed at the center O9 so as to be temporarily stopped. The concave portion 41A has a small concave spherical surface shape which is the same as that of the concave portion 41 of the manipulation device 301A shown in FIG. 7.

When the manipulation body 4 is in the neutral posture, the spherical protrusion is elastically pressed against the concave portion 41A, so that the operation body 3 and the manipulation body 4 are temporarily stopped in the neutral posture. When the manipulation body 4 is pushed down in one direction, the sense of resistance may be obtained a plurality of times by the concentric concave portions 26A, 27A, 28A, and 29A. Since the concave portions become deeper in the order of the concave portions 26A, 27A, and 28A, the sense of manipulation increases in a stepwise manner by largely pushing the manipulation body 4 down. Then, when the protrusion is fitted to the concave portion 29A of the outermost periphery, a smaller sense of resistance is obtained.

In the manipulation device 501 shown in FIG. 13, since four sets of concave portions are formed in the spherical surface 3a, the manipulation device may allow the manipulation body 4 to be temporarily stopped in the neutral posture, generate the sense of manipulation resistance a plurality of times in a stepwise manner in accordance with the push-down angle, and generate the sense of rotation resistance sixteen times when rotating the manipulation body 4.

Further, the embodiments shown in FIGS. 3, 4 and 6 or FIG. 13 may be further combined with the concave portions 41, 42, and 43 shown in FIG. 8 or the concave portions 41, 42, 43, 44, and 45 shown in FIG. 9.

A manipulation device 601 of the sixth embodiment shown in FIG. 4 is provided with the concave portion 21A of the set 20A shown in FIG. 13, and the concave portion 26A, 27A, 28A, 29A, and the positioning concave portion 41A of the set 25A.

Moreover, a concave portion 151 is formed so as to have a square locus about the center O10 corresponding to the intersection point between the normal line V10 and the spherical surface 3a.

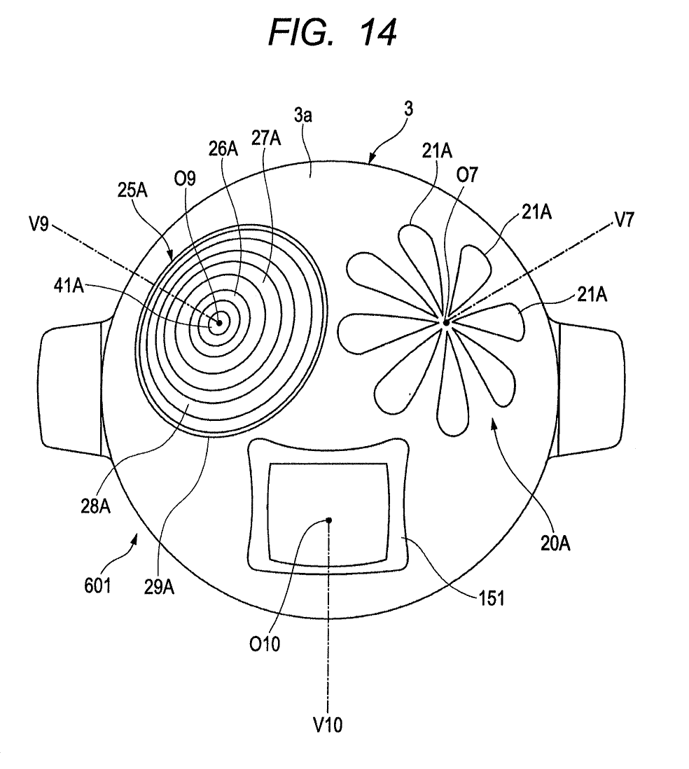

The manipulation device 601 shown in FIG. 14 may allow the manipulation body 4 to be temporarily stopped in the neutral posture and have a function of first guiding the manipulation body 4 by the regulation of the square through the rotation in the neutral position in addition to the generation of the sense of manipulation resistance when pushing the manipulation body 4 down and the sense of manipulation resistance when pushing the manipulation body 4 down and rotating the manipulation body.

Further, the embodiments shown in FIGS. 3, 4 and 6, and FIG. 13 or 14 may be combined with the concave portion 51 shown in FIG. 10, the concave portion 52 shown in FIG. 11, or the concave portion 53 shown in FIG. 12.

As described above, in the embodiments of the invention, the spherical surface 3a may be provided with one set of concave portions shown in all the above-described embodiments or may be provided with two or more sets of concave portions combined with any one of the concave portions.

It should be understood by those skilled in the art that various modifications, combinations, sub-combinations and alterations may occur depending on design requirements and other factors insofar as they are within the scope of the appended claims of the equivalents thereof.

What is claimed is:

1. A manipulation device comprising:
an operation body of which at least a part of a surface is provided with a spherical surface and which is rotatably supported by a support base;
a manipulation body, which rotates the operation body; and
a detection portion, which detects a rotation of the operation body,
wherein the spherical surface is provided with a concave portion, the support base is provided with a protrusion elastically pressed against the operation body and sliding on the spherical surface and the concave portion, and a plurality of the concave portions is provided in a radial shape about an intersection point between the spherical surface and a normal line thereof.

2. A manipulation device comprising:
an operation body of which at least a part of a surface is provided with a spherical surface and which is rotatably supported by a support base;
a manipulation body, which rotates the operation body; and
a detection portion, which detects a rotation of the operation body,
wherein the spherical surface is provided with a concave portion, the support base is provided with a protrusion elastically pressed against the operation body and sliding on the spherical surface and the concave portion, and a plurality of the concave portions is provided in a concentric shape about an intersection point between the spherical surface and a normal line thereof.

3. A manipulation device comprising:
an operation body of which at least a part of a surface is provided with a spherical surface and which is rotatably supported by a support base;
a manipulation body, which rotates the operation body; and
a detection portion, which detects a rotation of the operation body,
wherein the spherical surface is provided with at least concave portions of first and second sets, the support base is provided with a protrusion elastically pressed by the operation body and individually sliding on the concave portion of each set and the spherical surface, a plurality of the concave portions of the first set is provided in a radial shape about an intersection point between the spherical surface and a first normal line thereof, and a plurality of the concave portions of the second set is provided in a concentric shape about an intersection point between the spherical surface and a second normal line thereof.

4. The manipulation device according to claim 3,
wherein the first normal line and the second normal line are a common normal line, and the concave portions of the first set and the concave portions of the second set have a common center.

5. The manipulation device according to claim 1,
wherein a plurality of sets each including the plurality of concave portions provided in a radial shape is provided, the respective sets are disposed to be away from each other, and in each of the sets, arrangement phases of the concave portions in the rotation direction about the intersection point are deviated from each other.

6. The manipulation device according to claim 1,
wherein each of the concave portions becomes deeper further away from the center.

7. A manipulation device comprising:
an operation body of which at least a part of a surface is provided with a spherical surface and which is rotatably supported by a support base;
a manipulation body, which rotates the operation body; and
a detection portion, which detects a rotation of the operation body,
wherein the spherical surface is provided with a concave portion, the support base is provided with a protrusion elastically pressed against the operation body and sliding on the spherical surface and the concave portion, and when the concave portion is fitted to the protrusion, the operation body is temporarily stopped.

8. The manipulation device according to claim 7,
wherein when the manipulation body is in a neutral posture, the concave portion is fitted to the protrusion.

9. The manipulation device according to claim 7,
wherein the concave portion is provided at a plurality of positions, and in both cases where the manipulation body is in the neutral posture and the manipulation body further rotates from the neutral posture, the concave portion is fitted to the protrusion.

10. A manipulation device comprising:
an operation body of which at least a part of a surface is provided with a spherical surface and which is rotatably supported by a support base;
a manipulation body, which rotates the operation body; and
a detection portion, which detects a rotation of the operation body,
wherein the spherical surface is provided with a concave portion, the support base is provided with a protrusion elastically pressed against the operation body and sliding on the spherical surface and the concave portion, the concave portion extends in one rotation direction, and when the protrusion is fitted to the concave portion, the operation body is first guided in the direction along the concave portion.
